(19) United States
(12) Patent Application Publication
(10) Pub. No.: US 2016/0119810 A1
(43) Pub. Date: Apr. 28, 2016

(54) METHODS AND SYSTEMS FOR MULTI-USER TRANSMISSIONS DURING A TRANSMISSION OPPORTUNITY

(71) Applicant: QUALCOMM Incorporated, San Diego, CA (US)

(72) Inventors: Simone Merlin, San Diego, CA (US); George Cherian, San Diego, CA (US); Gwendolyn Denise Barriac, Encinitas, CA (US)

(21) Appl. No.: 14/920,695

(22) Filed: Oct. 22, 2015

Related U.S. Application Data
(60) Provisional application No. 62/069,773, filed on Oct. 28, 2014.

(51) Int. Cl. H04W 28/02; H04W 72/12; H04W 52/02

(52) U.S. Cl. CPC H04W 28/0231; H04W 52/0216; H04W 72/121

(57) ABSTRACT

Methods and apparatus for managing a wireless medium include, in one aspect, a method including generating a frame, the frame including a plurality of contiguous schedule blocks, each of the schedule blocks including a first indicator identifying a non-overlapping time interval during a transmission opportunity, and one or more second indicators of one or more devices to communicate within the identified time interval, wherein at least one of the schedule blocks is generated to identifying a plurality of devices to communicate on the medium during the corresponding identified time interval; and transmitting the frame from the device.

### CROSS REFERENCE TO RELATED APPLICATIONS

This application claims priority to U.S. Provisional Patent Application No. 62/069,773, filed Oct. 28, 2014, and entitled “METHODS AND SYSTEMS FOR MULTI-USER TRANSMISSIONS DURING A TRANSMISSION OPPORTUNITY.” The disclosure of this prior application is considered part of this application, and is hereby incorporated by reference in its entirety.

### FIELD

Certain aspects of the present disclosure generally relate to wireless communications, and more particularly, to methods and apparatus for multiple user communication in a wireless network.

### BACKGROUND

In many telecommunication systems, communications networks are used to exchange messages among several interacting spatially-separated devices. Networks may be classified according to geographic scope, which could be, for example, a metropolitan area, a local area, or a personal area. Such networks may be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

In order to address the issue of increasing bandwidth requirements that are demanded for wireless communications systems, different schemes are being developed to allow multiple user terminals to communicate with a single access point by sharing the channel resources while achieving high data throughputs. Thus, there is a need for improved methods of sharing a wireless medium between a variety of wireless devices.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

As discussed above, bandwidth requirements for wireless networks are increasing. This increase in the demand for bandwidth is driven at least in part by penetration of mobile devices into domains traditionally reserved for wired network solutions, including the streaming of video, music, and other types of content that may consume large portions of a network's capacity.

Existing wireless protocols may provide both contention and contention free periods when a device may transmit on a wireless network. During contention periods, transmissions may employ traditional collision sensing mechanisms. During contention free periods, the wireless medium is reserved for use by a particular device while other wireless devices refrain from transmission during that period. When a particular wireless device has multiple disparate data sets ready for transmission, or may receive multiple disparate data sets from multiple different devices, it may be desirable for a device to manage transmission and reception of this data during a transmission opportunity reserved for the device. For example, the device may partition the transmission opportunity into time periods for transmitting data and/or additional time periods for receiving data. Additionally, data may be transmitted and or received from multiple devices during these time periods, using traditional multi-user transmission methods such as multi-user multiple input, multiple output (MU-MIMO) or Orthogonal Frequency Division Multiplexing (OFDM).

To accomplish this partitioning, the device may transmit a scheduling frame before or during the transmission opportunity. The scheduling frame may communicate which devices will transmit data to the device, and which devices will receive data from the device during multiple time periods within the transmission opportunity. Additional frames, herein referred to as trigger frames, may also be transmitted during the transmission opportunity to indicate to particular devices that their transmissions to the device may be initiated after reception of the trigger frame. In some aspects, the scheduling frame may serve as a triggering frame, indicating to a set of devices that transmissions should be initiated right away, for example, during a time period immediately following or coincident with the scheduling frame.

One aspect disclosed is a method of managing usage of a wireless communication medium in a communication network including a transmitting device and a plurality of receiving devices. The method includes generating, by a transmitting device, a frame comprising a plurality of schedule blocks, each of the schedule blocks comprising: a first indicator identifying a non-overlapping time interval during a transmission opportunity, and one or more second indicators of one or more receiving devices to communicate within the identified non-overlapping time interval, wherein at least one of the plurality of schedule blocks identify a plurality of receiving devices to communicate within the non-overlapping time interval identified by the corresponding schedule block; and transmitting the frame from the transmitting device.

In some aspects, the method also includes determining a last packet transmitted during a time interval of the non-overlapping time intervals to a particular device of the plurality of receiving devices; and setting an indication in the last packet to a particular value in response to the determination; and transmitting the last packet to the particular device. In some aspects, the method includes determining a last packet transmitted during the transmission opportunity to a particular device of the plurality of receiving devices, setting an indication in the last packet to a particular value in response to the determination; and transmitting the last packet to the particular device. In some aspects, the method includes determining a last packet transmitted during a plurality of transmission opportunities to a particular device of the plurality of receiving devices, setting an indication in the last packet to a particular value in response to the determination; and transmitting the last packet to the first device.

In some aspects, the method also includes generating the frame to further indicate when one or more of the plurality of receiving devices indicated may enter a sleep state. In some aspects, the method also includes generating the frame to comprise a time reference indicator for each of the plurality of indicated time intervals. In some aspects, the method also includes generating the frame to comprise power control information for each of the plurality of receiving devices.

Another aspect disclosed is an apparatus for managing usage of a wireless medium in a communication network including a transmitting device and a plurality of receiving devices. The apparatus includes a processor configured to generate a frame comprising: a plurality of schedule blocks, each of the schedule blocks comprising a contiguous portion of the frame, and further comprising: a first indicator identifying a non-overlapping time interval during a transmission opportunity, and one or more second indicators of one or more receiving devices to communicate within the identified non-overlapping time interval, wherein at least one of the plurality of schedule blocks is generated to identify a plurality of receiving devices to communicate during the time interval identified by the corresponding schedule block; and a transmitter configured to transmit the frame from the apparatus.

In some aspects, the processor is further configured to: determine a last packet transmitted during the transmission opportunity to a particular device of the plurality of receiving devices, and set an indication in the last packet to a particular value in response to the determination. In these aspects, the transmitter is further configured to transmit the last packet to the particular device. In some aspects, the processor is further configured to: determine a last packet transmitted during the transmission opportunity to a particular device of the plurality of receiving devices, setting an indication in the last packet to a particular value in response to the determination. In these aspects, the transmitter is further configured to transmit the last packet to the particular device.

In some aspects, the processor is further configured to: determine a last packet transmitted during a plurality of transmission opportunities to a particular device of the plurality of receiving devices, and set an indication in the last packet to a particular value in response to the determination. In these aspects, the transmitter is further configured to transmit the last packet to the particular device.

In some aspects, the processor is further configured to generate the frame to indicate when one or more of the receiving devices may enter a sleep state. In some aspects, the processor is further configured to generate the frame to comprise a time reference indicator for each of the plurality of indicated time intervals. In some aspects, the processor is further configured to generate the frame to comprise power control information for each receiving device.

Another aspect disclosed is a method of communicating between a transmitting device and a receiving device on a wireless network. The method includes receiving, by a receiving device, a frame from a transmitting device over the wireless network, decoding, by the receiving device, the frame to identify a plurality of contiguous schedule blocks, decoding, by the receiving device, each of the plurality of schedule blocks to determine a corresponding plurality of non-overlapping time intervals during a transmission opportunity (TXOP), decoding, by the receiving device, each of the plurality of schedule blocks to identify at least one of the time intervals when the receiving device will perform a multi-user communication with the transmitting device; and communicating, by the receiving device, with the transmitting device during the identified at least one time interval.

In some aspects, the method may also include decoding the frame to determine sleep time information; and entering a sleep state based on the sleep time information. In some aspects, the method may also include receiving a multi-user data message from the transmitting device during one of the non-overlapping time intervals, decoding an indicator in the message to determine whether the data message is the last data message for the receiving device during the time interval; and entering a sleep state in response to determining the message is the last data message.

In some aspects, the method includes decoding a more data bit of the data message to determine whether the data transmission is the last data transmission. In some aspects, the method includes decoding the frame to determine a maximum duration of a transmission to the transmitting device during a time interval; and transmitting data less than or equal to the maximum transmission duration to the transmitting device during the time period based on the decoding. In some aspects, the method includes receiving a second frame, decoding the second frame to determine a start time within the time interval for a data transmission to the transmitting device; and transmitting data to the transmitting device at the determined start time. In some aspects, the method includes decoding the frame to determine a start time within the time interval for a transmission of data in a multi-user communication to the transmitting device. The method of claim 15, further comprising receiving a second frame, decoding the second frame to determine a start time within the time interval for a data transmission to the transmitting device; and transmitting data to the transmitting device at the determined start time.

Another aspect disclosed is an apparatus for communicating with a transmitting device on a wireless network including a transmitting device. The apparatus includes a receiver configured to receive from the transmitting device, a frame from the wireless network, a processor configured to decode the frame to identify a plurality of contiguous schedule blocks, decode each of the plurality of schedule blocks to determine a corresponding plurality of non-overlapping time intervals during a transmission opportunity (TXOP), decoding each of the plurality of schedule blocks to identify at least one of the time intervals when the apparatus will perform a multi-user communication with the transmitting device; and communicate with the transmitting device during the identified at least one time interval. In some aspects of the apparatus, the processor is further configured to decode the frame to determine sleep time information, and enter a sleep state based on the sleep time information.

In some aspects of the apparatus, the processor is further configured to receive a multi-user data message from the transmitting device during one of the non-overlapping time intervals, decode an indicator in the message to determine whether the data message is the last data message for the apparatus during the time interval, and enter a sleep state in response to determining the message is the last data message. In some aspects of the apparatus, the processor is further configured to decode a more data bit of the data message to determine whether the data transmission is the last data transmission. In some aspects of the apparatus, the processor is further configured to decode the frame to determine a maximum duration of a transmission to the transmitting device during a time interval. In these aspects, the transmitter is further configured to transmit data less than or equal to the maximum transmission duration to the transmitting device during the time period based on the decoding.

In some aspects of the apparatus, the processor is further configured to decode the frame to determine a start time within the time interval for a transmission of data in a multi-user communication to the transmitting device. In some aspects of the apparatus, the receiver is further configured to receive a second frame, wherein the processor is further configured to decode the second frame to determine a start time within the time interval for a data transmission to the transmitting device. In some of these aspects, the transmitter is further configured to transmit data to the transmitting device at the determined start time.

In some aspects of the apparatus, the processor is further configured to decode the frame to determine a start time within the time interval for a transmission of data in a multi-user communication to the transmitting device.

### BRIEF DESCRIPTION OF THE DRAWINGS

FIG. 1 illustrates a multiple-access multiple-input multiple-output (MIMO) system with access points and user terminals.

FIG. 2 illustrates a block diagram of the access point and two user terminals in a MIMO system.

FIG. 3 illustrates various components that may be utilized in a wireless device that may be employed within a wireless communication system.

FIG. 4 is a time sequence diagram that, in conjunction with FIG. 1, illustrates an example of an operation mode of multi-user transmissions during a transmission opportunity.

FIG. 5 is a time sequence diagram that, in conjunction with FIG. 1, illustrates an example of an operation mode of multi-user transmissions during a transmission opportunity.

FIG. 6 shows transmission of a separate trigger message 603 transmitted by a TXOP owner before a multi-user transmission to the TXOP owner is performed.

FIG. 7A is a partial message format of a scheduling message.

FIG. 7B shows one implementation of a common info field.

FIG. 7C shows one implementation of a device info field.

FIG. 8 is a method of scheduling communication during a transmission opportunity.

FIG. 9 is a method of communicating during a transmission opportunity.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing this particular wireless protocol may consume less power than devices implementing other wireless protocols, may be used to transmit wireless signals across short distances, and/or may be able to transmit signals less likely to be blocked by objects, such as humans.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA may also be used as an AP.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station “STA” may also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

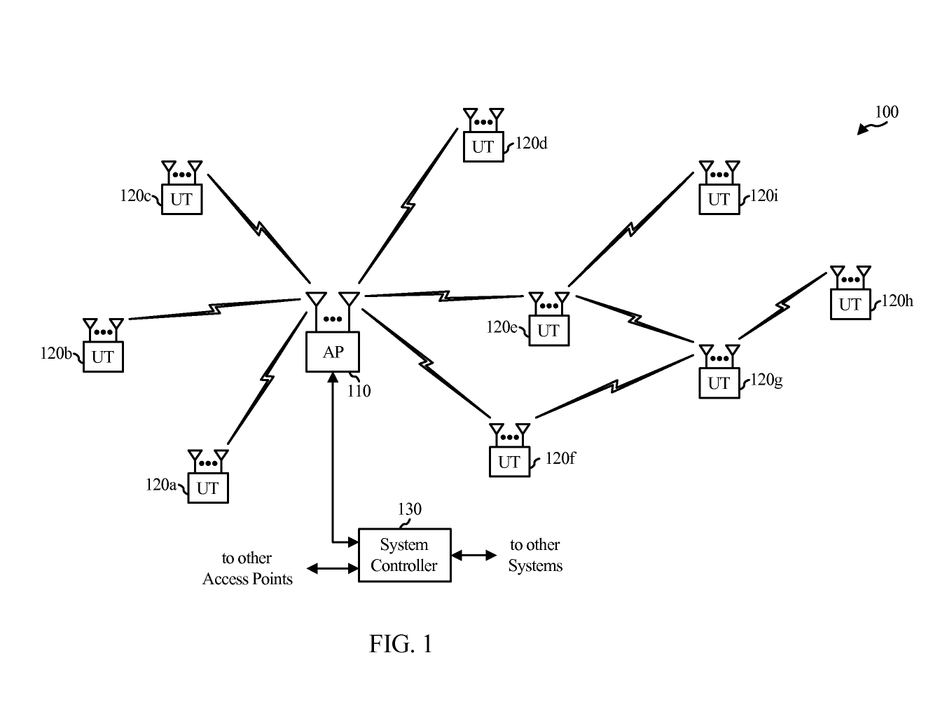

FIG. 1 is a diagram that illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or using some other terminology. A user terminal or STA may be fixed or mobile and may also be referred to as a mobile station or a wireless device, or using some other terminology. The access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, the AP 110 may be configured to communicate with both SDMA and non-SDMA user terminals. This approach may conveniently allow older versions of user terminals (“legacy” stations) that do not support SDMA to remain deployed in an enterprise, extending their useful lifetime, while allowing newer SDMA user terminals to be introduced as deemed appropriate.

The multiple-access multiple-input multiple-output (MIMO) system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≦K≦1 if the data symbol streams for the K user terminals are not multiplexed in code, frequency or time by some means. K may be greater than Nₐₚ if the data symbol streams can be multiplexed using TDMA technique, different code channels with CDMA, disjoint sets of sub-bands with OFDM, and so on. Each selected user terminal may transmit user-specific data to and/or receive user-specific data from the access point. In general, each selected user terminal may be equipped with one or multiple antennas (i.e., Nᵤₜ≧1). The K selected user terminals can have the same number of antennas, or one or more user terminals may have a different number of antennas.

The multiple-access multiple-input multiple-output (MIMO) system 100 may be a time division duplex (TDD) system or a frequency division duplex (FDD) system. For a TDD system, the downlink and uplink share the same frequency band. For an FDD system, the downlink and uplink use different frequency bands. The multiple-access multiple-input multiple-output (MIMO) system 100 may also utilize a single carrier or multiple carriers for transmission. Each user terminal may be equipped with a single antenna (e.g., in order to keep costs down) or multiple antennas (e.g., where the additional cost can be supported). The multiple-access multiple-input multiple-output (MIMO) system 100 may also be a TDMA system if the user terminals 120 share the same frequency channel by dividing transmission/reception into different time slots, where each time slot may be assigned to a different user terminal 120.

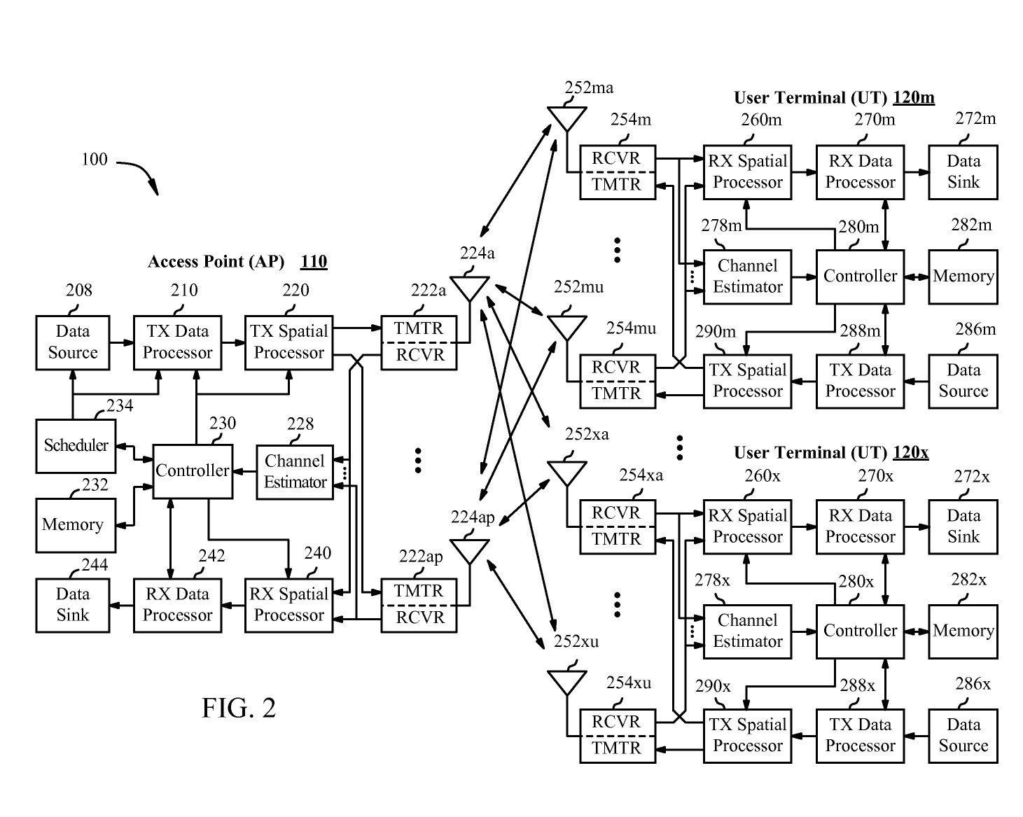

FIG. 2 illustrates a block diagram of the access point 110 and two user terminals 120m and 120x in multiple-access multiple-input multiple-output (MIMO) system 100. The access point 110 is equipped with Nₜ antennas 224a through 224ap. The user terminal 120m is equipped with N_{ut,m} antennas 252ₘₐ through 252ₘᵤ, and the user terminal 120x is equipped with N_{ut,x} antennas 252ₓₐ through 252ₓᵤ. The access point 110 is a transmitting entity for the downlink and a receiving entity for the uplink. The user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, and N_{dn} user terminals are selected for simultaneous transmission on the downlink. Nᵤₚ may or may not be equal to N_{dn}, and Nᵤₚ and N_{dn} may be static values or may change for each scheduling interval. Beam-steering or some other spatial processing technique may be used at the access point 110 and/or the user terminal 120.

On the uplink, at each user terminal 120 selected for uplink transmission, a TX data processor 288 receives traffic data from a data source 286 and control data from a controller 280. The TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252, for example to transmit to the access point 110.

Nᵤₚ user terminals may be scheduled for simultaneous transmission on the uplink. Each of these user terminals may perform spatial processing on its respective data symbol stream and transmit its respective set of transmit symbol streams on the uplink to the access point 110.

At the access point 110, Nᵤₚ antennas 224a through 224ₐₚ receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nᵤₚ received symbol streams from Nᵤₚ receiver units 222 and provides Nᵤₚ recovered uplink data symbol streams. The receiver spatial processing may be performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at the access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. The TX data processor 210 provides N_{dn} downlink data symbol streams for the N_{dn} user terminals. A TX spatial processor 220 performs spatial processing (such as a precoding or beamforming) on the N_{dn} downlink data symbol streams, and provides Nᵤₚ transmit symbol streams for the Nᵤₚ antennas. Each transmitter unit 222 receives and processes a respective transmit symbol stream to generate a downlink signal. Nᵤₚ transmitter units 222 may provide Nᵤₚ downlink signals for transmission from Nᵤₚ antennas 224, for example to transmit to the user terminals 120.

At each user terminal 120, N_{ut,m} antennas 252 receive the Nᵤₚ downlink signals from the access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal 120. The receiver spatial processing may be performed in accordance with the CCMI, MMSE, or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. The controller 280 for each user terminal may send feedback information (e.g., the downlink and/or uplink eigenvectors, eigenvalues, SNR estimates, and so on) to the access point 110. The controllers 230 and 280 may also control the operation of various processing units at the access point 110 and user terminal 120, respectively.

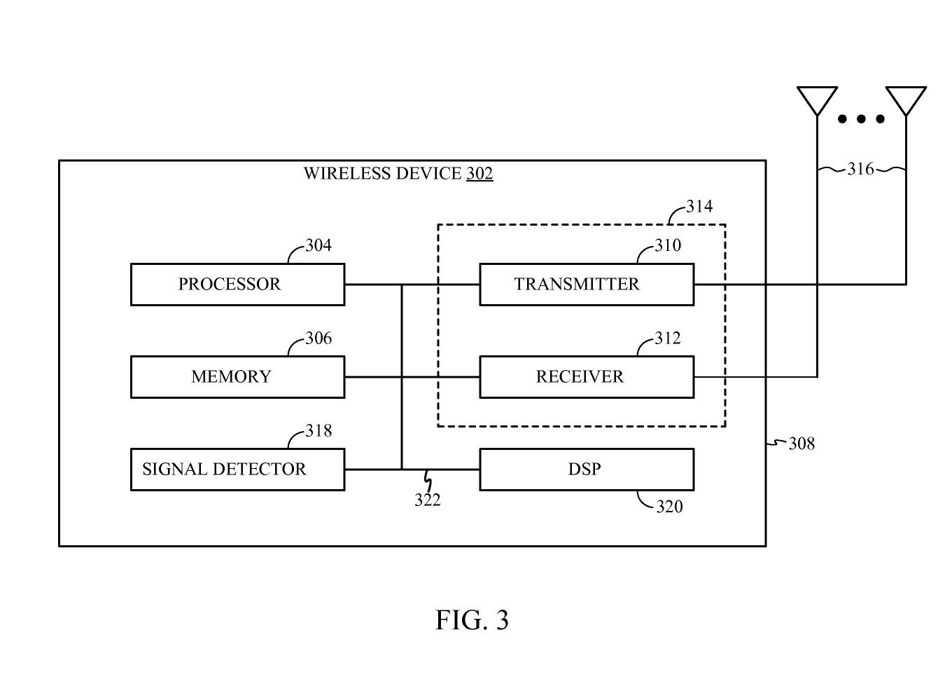

FIG. 3 illustrates various components that may be utilized in a wireless device 302 that may be employed within the multiple-access multiple-input multiple-output (MIMO) system 100. The wireless device 302 is an example of a device that may be configured to implement the various methods described herein. The wireless device 302 may implement an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 may perform logical and arithmetic operations based on program instructions stored within the memory 306. The instructions in the memory 306 may be executable to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transceiver antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

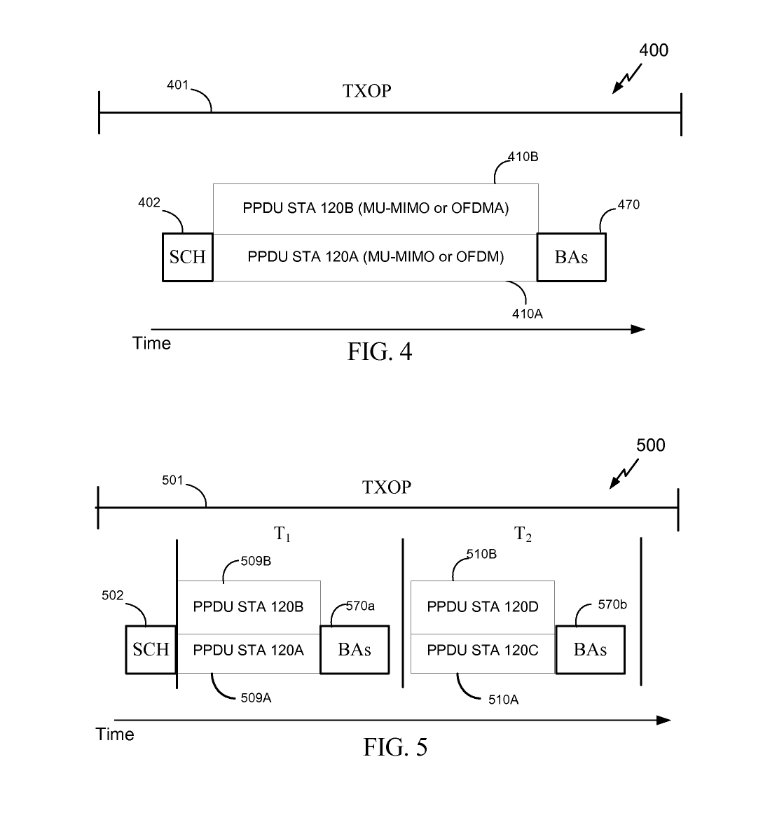

Certain aspects of the present disclosure support transmitting an uplink (UL) signal from multiple STAs to an AP. In some embodiments, the UL signal may be transmitted in a multi-user MIMO (MU-MIMO) system. Alternatively, the UL signal may be transmitted in a multi-user FDMA (MU-FDMA) or similar FDMA system. Specifically, FIGS. 4-7 illustrate UL-MU-MIMO transmissions 410A, 410B, that would apply equally to UL-FDMA transmissions. In these embodiments, UL-MU-MIMO or UL-FDMA transmissions can be sent simultaneously from multiple STAs to an AP and may create efficiencies in wireless communication.

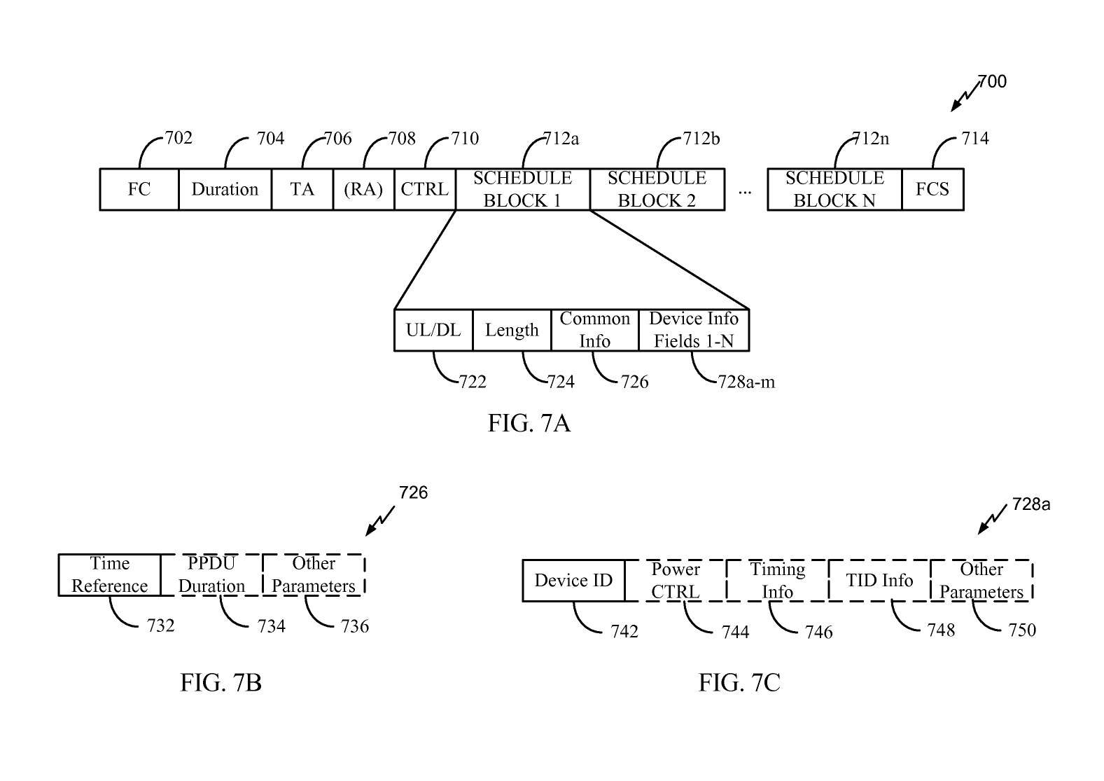

FIG. 4 is a time sequence diagram illustrating an example of a multi-user communication 400 within a transmission opportunity 401. As shown in FIG. 4 and in conjunction with FIG. 1, an AP 110 may transmit a scheduling (SCH) message 402 to the user terminals 120a-b indicating which STAs may participate in the MU-MIMO communication. An example of a scheduling message frame structure is described more fully below with reference to FIG. 7. In some aspects, the scheduling message 402 may be a clear to transmit (CTX) message. In some aspects, the multi-user communication is specified as being uplink or transmitted to the txop owner device or downlink, or transmitted from the txop owner device.

Once a user terminal 120 receives the scheduling message 402 from the AP 110 where the user terminal is identified, the user terminal may participate in the MU-MIMO communication 410. In FIG. 4, STA 120A and STA 120B transmit MU-MIMO transmission 410A and 410B containing physical layer convergence protocol (PLCP) protocol data units (PPDUs). These transmissions may occur at least partially simultaneously. Upon receiving the uplink MU-MIMO transmission 410, the AP 110 may transmit block acknowledgments (BAs) 470 to the user terminals 120.

FIG. 5 is a time sequence diagram that, in conjunction with FIG. 1, illustrates an example of an operation mode of multi-user transmissions during a transmission opportunity 501. In this embodiment, user terminals 120A-D receive a scheduling message 502 from a TXOP owner (not shown). The scheduling message 502 includes scheduling information for the transmission opportunity 501. For example, the scheduling message 502 may specify two or more time periods within the TXOP 501. As shown in FIG. 5, the scheduling message 502 defines two time periods T₁ and T₂. The scheduling message 502 may further define one or more devices that may communicate during each of the time periods. At least one of the time periods is defined to include a multi-user communication with two or more devices. For example, as shown in FIG. 5, STAs 120A and STA 120B are communicating via a multi-user communication 509a-b during the time period T₁. STAs 120C and STA 120D are communicating via a multi-user communication 510A-B during time period T₂. Communications 509A-B and 510A-B may employ one or more of multi-user multiple input multiple output (MU-MIMO) or Orthogonal Frequency Division Multiplexing (OFDM). During the time periods T₁ and/or T₂, the multi-user communication may include at least partial simultaneous transmission or reception of messages between the TXOP owner and other devices (such as STAs 120A-B or STAs C-D) communicating during the time period.

Each of multi-user communications 509A-B and 510A-B may be either uplink or downlink transmissions. In some aspects, the scheduling message 502 may indicate the direction of communication for each of communications 509A-B and 510A-B. (Note that 509A and 509B may be both either transmitted from the TXOP owner or transmitted to the TXOP owner) Within each of the time periods T₁ and T₂, PPDU's transmitted during the respective time periods may also be acknowledged during the same time period. For example, block acknowledgement 570a acknowledges communications 509A-B while block acknowledgments 570b acknowledge communications 510A-B. In one aspect, the block acknowledgements may be transmitted a short time (e.g. SIFS) after the end of the PPDUs. In one aspect, the time of the block acknowledgements may be specified by the scheduling message. If communications 509A-B are uplinked from STAs 120A-B, then a receiving TXOP owner may transmit the block acknowledgments 570a during time period T₁. If communications 510C-D are transmitted by a TXOP owner, then block acknowledgments 570b may be transmitted by devices receiving the communication (i.e. STA 120A and STA 120B in the illustrated aspect) during time period T₂. In some aspects, the scheduling message 502 may further indicate that devices sending uplink data during the first time period T₁ should initiate their uplink transmissions 509A-B after receipt of the scheduling message 502. Alternatively, in some aspects the scheduling message 502 may indicate a time at which the communications 509A-B should be transmitted by the STAs 120A-B. In some aspects, the order of communications 509A-B and 510A-B may be reversed from that shown. For example, uplink transmissions may follow downlink transmissions during transmission opportunity 501. In this case, the scheduling message 502 may not act as a trigger message for uplink communications 509A-B. Instead, a separate trigger message may be transmitted by the TXOP owner. In some aspects, the scheduling message 502 may be a clear to transmit (CTX) message.

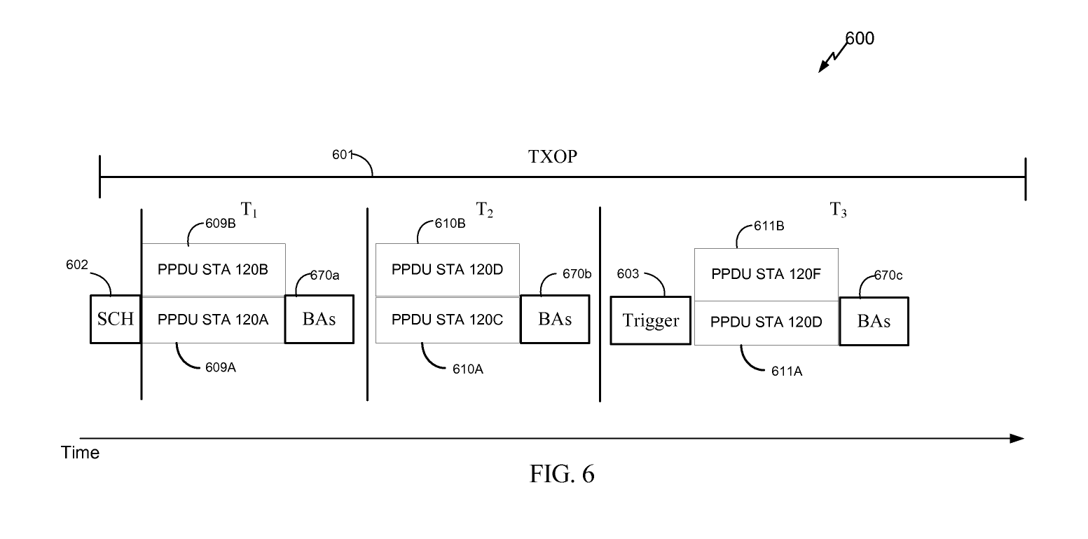

FIG. 6 shows transmission of a separate trigger message 603 transmitted by a TXOP 601 owner before a multi-user transmission 611A-B to the TXOP owner is performed. Similar to FIG. 5, FIG. 6 shows a TXOP 601 divided into at least three time periods T₁-T₃. The multi-user transmissions 609A-B, 610A-B, and 611A-B shown in FIG. 6 may include simultaneous transmissions from/to a plurality of devices, for example, using MU-MIMO or OFDM. In one aspect, the separate trigger message 603 may be omitted. In these aspects, the scheduling message 602 may indicate the start time of the uplink transmissions 611A and 611B.

A scheduling message 602 is transmitted by a TXOP owner (not shown) during the TXOP 601. As discussed above with respect to scheduling messages 402 and 502, scheduling message 602 may define or indicate a plurality of non-overlapping time periods T₁-T₃ within the TXOP 601. The scheduling message may further indicate devices that will communicate during each of the time periods T1-T3. During at least one of the time periods, a multi-user communication will be performed between the TXOP owner and at least two other devices. As shown, during each of the time periods T1-T3, two devices communicate with the TXOP owner using multi-user communication. In some aspects, devices communicating during a time period may be identified by the TXOP owner via scheduling message 602 by indicating their association identifier (AID), media access control (MAC) address, or group identifier in the scheduling message 602. In some aspects, more than two devices may perform multiuser communication with the TXOP owner during a time period T₁-T₃. The scheduling message 602 may also indicate whether communication during each of the time periods is uplink or downlink communication.

In the illustrated aspect, communications 609A-B may be transmitted by stations 120A-B to the TXOP 601 owner. In some aspects, the scheduling message 602 may include an indicator, for example, a field or bit in the message 602, that functions to indicate to the STAs 120A-B devices that they should initiate transmissions of communications 609A-B after the scheduling message 602 is received. In some aspects, communications should be initiated after a fixed or predefined time period after reception of the scheduling message 602 is received, for example, a short inter-frame space (SIFS) time. In other aspects, the scheduling message 602 may indicate (via a field or bit in the scheduling message 602) the amount of time after reception of the scheduling message 602, or at a particular time offset within a given time period, that transmissions 609A-B should be initiated to the TXOP 601 owner. In some aspects, receiving devices may initiate a transmission to the TXOP owner based on reception of the scheduling message 602. After communications 609A-B are received by the TXOP 601 owner, the TXOP 601 owner may transmit block acknowledgments 670a to STA 120A and STA 120B.

During time period T₂, multi-user communication 610A-B is performed with STA 120C and 120D respectively. If communications 610A-B are transmitted by the TXOP owner to the STAs 120C-D, then the STAs 120C-D may transmit block acknowledgments 670b to the TXOP 601 owner during the time period T₂.

Scheduling message 602 may indicate that communications during time period T₃ are to be transmitted to the TXOP 601 owner device. Before communications 611A-B are initiated during time period T₃, the TXOP 601 owner device may transmit the trigger message 603. The trigger message 603 may indicate to STA D and STA F a time for initiating transmissions 611A-B to the TXOP 601 owner device. As discussed above with respect to the scheduling message 602 operating as a trigger message for communications 609A-B, the trigger message 603 may indicate to STA 120D and STA 120F that communications 611A-B should be initiated a fixed or predetermined time period after reception of the trigger message 603 is complete. Alternatively, the trigger message 603 may indicate an amount of time after reception of the trigger message 603 the transmission of communications 611A-B should be initiated. Alternatively, the initiation of the transmissions may be indicated by the trigger message 603 specifying a time offset within time interval T₃. After communications 611A-B are performed, the TXOP 601 owner device may transmit block acknowledgments 670c during the time period T₃. Note that while both FIGS. 5 and 6 show the transmission of block acknowledgments, in some aspects, regular acknowledgment messages may be used to acknowledge communications discussed herein. Note also that while FIG. 6 shows first communications transmitted to a TXOP 601 owner device (609A-B) being triggered by the scheduling message 602, in some aspects, a separate trigger message, similar to trigger message 603 may be transmitted during time period T1 to control initiation of communications 609A-B to the TXOP 601 owner device.

In some aspects, stations on a wireless network may determine time periods for entering a sleep state based on the scheduling message 602. For example, the STA 120B may determine that it may enter a sleep state from a time period after receiving acknowledgement for the transmission 609B at least until the end of time period T₃. Similarly, STA 120F may determine it may enter a sleep state during time periods T₁-T₂, but must be ready to receive information during time period T₃. In some aspects, these determinations are made based on indications of the time periods T1-T3, and stations assigned to communication during each of those time periods T1-T3 provided in scheduling message 602. In some aspects, scheduling message 602 includes explicit indications (such as fields or bits) that provide sleep time information to one or more stations. For example, the explicit indications may define time offsets and durations within the TXOP 601 during which a station or group of stations may enter a sleep state.

In some aspects, the scheduling message 602 may further indicate whether the TXOP owner will transmit additional SCH frames after the scheduling message 602. An additional scheduling message may provide additional scheduling information for devices scheduled in frame 602.

For example, the schedule frame 602 may indicate to particular devices that they will be scheduled in additional scheduling frames after the current TXOP. These particular devices should wake after the TXOP is completed such that a the second SCH message may be received. In some aspects, a more data bit in a frame control field of the SCH frame 602 may be used for this purpose. For example, if the more data bit is set to a particular value, receiving devices will leave a sleep state or otherwise be ready to communicate with the TXOP owner after the TXOP 601 is complete. If the more data bit is set to a different particular value, receiving devices may not necessarily leave the sleep state after the TXOP, but may leave the sleep state based on other parameters associated with the wireless network.

FIG. 7A is a partial message format of a scheduling message. In some aspects, one or more of the scheduling messages 402, 502, and/or 602 may substantially conform with aspects of message format 700.

Message format 700 includes a frame control field 702, duration field 704, transmitter address field 706, receiver address field 708, control field 710, one or more schedule block fields 712a-n, and a frame check sequence field 714.

Each of schedule block fields 712a-n may, among other things, identify a time period within a transmission opportunity during which at least some multi-user communications are performed. Schedule block fields 712a-n include an uplink/downlink indicator field 722, length field 724, common info field 726, and one or more device info fields 728a-m. The uplink/downlink indicator field 722 indicates whether uplink or downlink communications will be performed during the time period identified by the corresponding schedule block (via time reference in common info field 726, discussed below). The length field 724 indicates a length of the time period defined by the corresponding schedule block field. In some aspects, the schedule blocks be in in a contiguous portion of a frame formatted according to message format 700.

FIG. 7B shows one implementation of a common info field 726. The common info field 726 includes a time reference 732, and may optionally include a physical protocol data unit duration field 734 and an other parameters field 736. In some aspects, fields 734 and 736 may be included in common info field 726 when the UL/DL field 722 indicates communication performed during the time period will be uplink transmissions. Time reference 732 indicates a start time for a time period within a transmission opportunity. The schedule block 712 including the time reference defines how communication occurs within the time period indicated by time reference field 732. The PPDU duration field 734 indicates a maximum length of a PPDU that may be transmitted to a TXOP owner transmitting the scheduling message during the time period identified by the corresponding scheduling block 712. In one aspect, the length field 724 may be used by receiving devices to determine the start time of each block. In these aspects, a start time and PPDU length for the corresponding time interval may be derived from the length fields in each of the scheduling blocks. (ex 724). In these aspects, the common info field may omit the PPDU duration 734 and time reference field 732.

FIG. 7C shows one implementation of a device info field 728a. The device info field includes a device identifier field 732, power control field 744, timing information field 746, traffic identifier information field 748, and an other parameters field 750. Device identifier field 742 may identify one or more devices on the wireless network that are to perform communications during the time period identified by the time reference field 732 of the common info field 726. In some aspects, the device identifier field 742 may indicate an AID of a device to perform communication during the time period. In some aspects, the device identifier field 742 may indicate a MAC address of a device to perform communication during the time period. In some aspects, the device identifier field 742 may indicate a group identifier of one or more devices to perform communication during the time period. In some aspects the device identifier field 742 may indicate one or more device capabilities. If a device receiving the device id field 742 possesses or includes the identified capability, the message 700 may indicate the device will communicate during the corresponding time period in these aspects.

In some aspects, the power control field 744 may indicate to devices identified by the device id field 742 portions of time within a time period identified by the corresponding schedule block 712 when the identified devices may be in a sleep state.

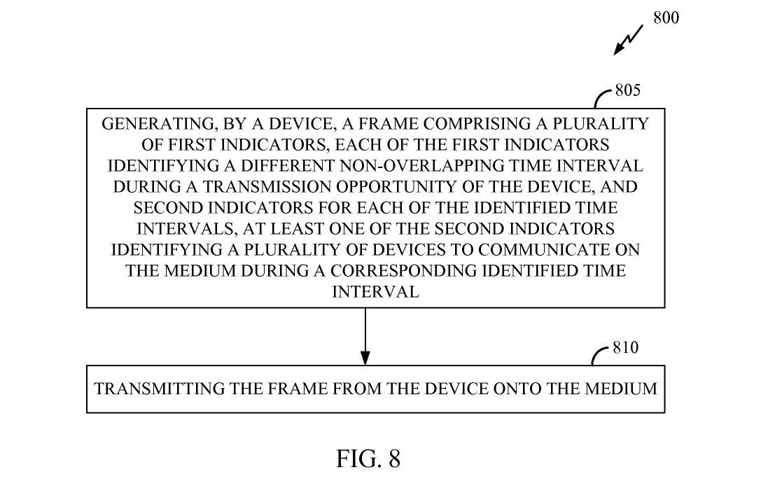

FIG. 8 is a method of scheduling communication during a transmission opportunity. The process 800 may be performed, in some aspects, by the wireless device 302, and/or an AP 110 and/or any of STA's 120 discussed above. In some aspects, the process 800 is performed by a TXOP owner.

Process 800 may provide for more efficient allocation of a wireless communications medium in a communication network. The communication network may include a transmitting device and a plurality of receiving devices. Both the transmitting device and the plurality of receiving devices may both transmit and receive information on the communication network.

By scheduling time periods during a transmission opportunity when multi-user communication may be performed between a TXOP owner and other devices on the wireless network, a transmission opportunity may be utilized to both send and receive data from multiple sets (or groups) of devices. For example, as shown above with respect to FIG. 6, the transmission opportunity may be used to receive multi-user data from a first set of devices, transmit multi-user data to a second set of devices, and receive multi-user data from a third set of devices. In some aspects, the first, second, and/or third set of devices may overlap. In some aspects, process 800 may generate the frame 700 described above with respect to FIG. 7. The transmission opportunity may be a contention free period on the wireless medium that is managed or owned by the device.

In block 805, a frame is generated by a device. In some aspects, the device generating the frame may be referred to as a transmitting device, in that it transmits the frame after generating it. The frame generated in block 805 may be any of the scheduling messages 402, 502, or 602 discussed above. In some aspects, the frame generated in block 805 is a clear to transmit (CTX) frame. The frame is generated to comprise a plurality of first indicators. In some aspects, the frame is generated to include a plurality of schedule blocks as shown in FIGS. 7A-C. Each of the first indicators identifies a different non-overlapping time interval during a transmission opportunity. The transmission opportunity may be owned by the device generating the frame or, in theory, by another device. In some aspects, the frame is generated to comprise a plurality of schedule blocks, with each schedule block including indicators identifying a non-overlapping time interval during the transmission opportunity, as shown for example, in FIG. 7A, and a plurality of schedule blocks 712a-n. For example, as shown in FIG. 6, the frame generated in block 805 may identify time periods T₁-T₃. As shown in FIG. 7, each time period may be identified, in some aspects, by a time reference field 732 and length field 724.

The frame is also generated to include one or more second indicators for each of the identified non-overlapping time intervals. At least one of the second indicators identifies a plurality of devices to communicate during the corresponding identified time interval. The plurality of devices may be referred to as a plurality of receiving devices in some contexts to communicate that these devices are receiving the frame generated in block 805. As shown in FIG. 8, each schedule block 712a-n may include in some aspects device info fields 728a-m. In some aspects, the device info fields 728a-m may be the second indicator discussed above. In some aspects, the frame may include one device info field for every identified device. Each device may be identified via a media access control address, association identifier, device capabilities, or group identifier. In some aspects, values of a second indicator may be defined to correspond to particular device capabilities. If a receiving device includes the identified capability, the frame may indicate the device will communicate during the time period identified by the corresponding schedule block in these aspects. In some aspects, the device info field may identify a plurality of devices, for example, using a group identifier.

In some aspects, the frame is also generated to include an additional third indicator for each of the identified time intervals. The third indicators indicate to devices receiving the frame whether the device will perform uplink or downlink transmissions during the corresponding identified time interval. In some aspects, the third indicators may be included in the schedule blocks discussed above. As shown in FIG. 7A, uplink/downlink indicator field 722 may perform this function in some aspects. When data will be sent on the uplink during a time interval, the frame may be generated to indicate a maximum physical protocol data unit duration that may be used for the UL data. For example, as shown in FIG. 7B, PPDU duration field 734 may perform this function in some aspects.

In some aspects, the frame is generated to include an additional indicator for the plurality of identified time intervals, the additional indicator indicating a time reference. In some aspects, each schedule block may include an additional indicator. The time reference may indicate a start time for the corresponding time interval. In some aspects, the time reference may indicate the start time relative to the transmission of the frame, or relative to a start time of the transmission opportunity.

In some aspects, the frame is generated to indicate a start time for a transmission to the transmission opportunity owning device that occurs during one of the identified time intervals. For example, if a first occurring identified time interval will be used for transmitting multi-user data to the TXOP owner device, the frame may be generated to trigger that transmission, or indicate when the transmitting devices should initiate that transmission.

In some aspects, the frame is generated to include device sleep information. The device sleep information may indicate when one or more devices may enter a sleep state during the transmission opportunity. The sleep time information may identify a plurality of sleep time periods, and also identify one or more devices that may sleep during each of the sleep time periods. In some aspects, the frame is further generated to include power control information for devices sending uplink data during a time interval. In some aspects, one or more of the functions discussed above with respect to the generation of the frame may be performed by the processor 304.

In block 810, the frame is transmitted from the transmitting device onto the wireless medium. In some aspects, the frame is transmitted to all the receiving devices identified in the frame. For example, if only a single device or single group of devices is scheduled for communication during the transmission opportunity, the frame may be transmitted to only those devices. In some aspects, the frame is broadcast or multicast on the medium. Devices may receive the frame and decode it to determine whether they will communicate during each of the indicated time intervals. If a device receiving the frame determines it is not scheduled to communicate during a time interval or the TXOP generally, the receiving device may enter a sleep state for the duration of the time interval or TXOP in response to the determination.

As shown above with respect to FIGS. 5 and 6, after the frame is transmitted in block 810, the device may perform multi-user communications with a plurality of devices identified by the transmitted frame. In various aspects, the multi-user communication(s) may be performed using multi-user multiple input multiple output (MU-MIMIO) or using orthogonal frequency division multiplexing (OFDM). For example, the device may transmit or receive messages simultaneously with two or more of the identified devices during an identified time interval.

The frame generated in block 805 may be generated to indicate control information for the multi-user transmissions. For example, the device may assign channels and or frequencies to each device that will communicate during a multi-user communication. If MU-MIMO is used, the frame may be generated to indicate spatial channel assignments for each identified station to communicate during a particular time interval. If OFDM is utilized for communication, the frame may be generated to indicate frequency assignments for each identified station to communicate during a particular time interval. The multi-user communication may then be performed in accordance with the assignments by the device. The multi-user control information may vary for each time interval. Therefore, in some aspects, each of device info fields 728a-m may include the multi-user control information.

In some aspects, a second device is identified by the frame, with the frame indicating the second device is to receive data during a first time period, with the first time period also identified by the frame as one of the non-overlapping time intervals. In some of these aspects, before the device transmits a particular data message to the identified second device, the device determines whether the data message is a “last” data message transmitted to the second device. Is some aspects “last” refers to the last message in that time period. In some aspects “last” refers to the last message in the TXOP. In some other aspects “last” refers to the last packet the transmitter currently has available for that receiver. Thus, this may be the last packet in a plurality of transmission opportunities. In some aspects, the device may set an indicator in the last data message to a particular value, the particular value indicating the message is the last data message. In some aspects, this indicator is a more data bit. In some aspects, the more data bit is included in the frame control field 702. In some aspects, the transmitting device may be a STA. In some aspects, process 800 further includes transmitting a trigger frame during an identified time interval. The trigger frame is transmitted to indicate that devices communicating during the identified time interval should initiate transmissions to the transmission opportunity owning device. In some aspects, the trigger frame may indicate that the transmissions should be initiated after a predetermined elapsed time after reception of the trigger frame, for example, a short inter-frame space time (SIPS). Alternatively, the trigger frame may include a time indicator (via a field or series of bits) that indicates an offset from the starting time of the identified time interval when these transmissions should be initiated. Process 800 may further include receiving data from the devices communicating during the identified time interval. In some aspects, the functions discussed above with respect to block 810, as well as the description after the description of block 810, may be performed by one or more of the processor 304, transmitter 310, and/or receiver 312.

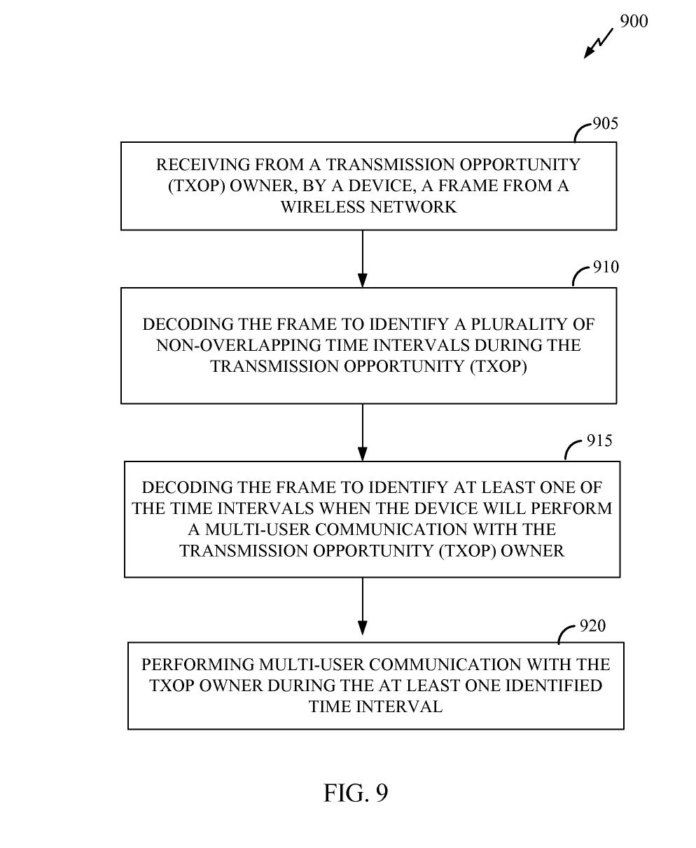

FIG. 9 is a method of communicating during a transmission opportunity. The process 900 may be performed, in some aspects, by the wireless device 302, and/or an AP 110 and/or any of STA's 120 discussed above. In some aspects, the process 900 is performed by a device that will communicate with a TXOP owner during the TXOP. The TXOP is a contention free period on the wireless network managed by the TXOP owner. In some aspects, during the TXOP, devices that do not own the transmission opportunity should not initiate transmissions unless scheduled by the frame received in block 905.

Process 900 may provide for more efficient allocation of a wireless medium. By scheduling time periods during a transmission opportunity when multi-user communication may be performed between the TXOP owner and other devices on the wireless network, devices may more readily determine periods of time when they will not be receiving or transmitting data on the network. This may enable the devices to enter a sleep state during periods of device inactivity on the network. For example, by entering a sleep state, in some aspects, a device may transition one or more hardware components into a mode that consumes less power than another type of operating mode. For example, hardware components or portions of hardware components that receive and/or transmit data on the wireless network may be powered down such that the transmit and/or receive chips consume less power during an inactive period of the network. Because these hardware components may be placed in an inoperative mode during the sleep mode, communication occurring on the wireless network may not be received by a device in the sleep state. After the period of inactivity defined by the scheduling message has passed, the device may exit the sleep mode and begin operating on the wireless network again. This cycle may repeat, with the device periodically entering and returning from a low power mode based on wireless communication activity scheduled by the scheduling message discussed below. In some aspects, process 900 may receive and decode the frame 700 discussed above with respect to FIG. 7.

In block 905, a frame is received by a device from a transmission opportunity (TXOP) owner. The frame may be received during the transmission opportunity (TXOP) itself, or in some aspects, at some time before the transmission opportunity begins. In some aspects, the frame received in block 905 may be any of the scheduling messages 402, 502, or 602 discussed above. In some aspects, one or more functions described with respect to block 905 may be performed by the receiver 312.

In block 910, the frame is decoded to identify a plurality of non-overlapping time intervals during the transmission opportunity. For example, as shown in FIG. 7A-C, one implementation of the received frame includes one or more schedule blocks 712. Each schedule block 712 identifies a time interval within the transmission opportunity. In some aspects, the time interval is identified at least in part via the time reference field 732 within each schedule block 712. In some aspects, one or more of the functions discussed above with respect to block 910 may be performed by the processor 304.

In block 915, the frame is decoded to identify at least one of the time intervals when the device will perform a multi-user communication with the transmission opportunity owner device. To identify the at least one time interval, one or more device identifiers may be decoded from the frame for each of the identified time intervals. For example, in some aspects, each schedule block may be decoded to identify a non-overlapping time interval, and one or more devices that are to communicate with the access point during the non-overlapping time interval identified by the schedule block.

The decoded device identifiers may be one or more of an association identifier, media access control address, device capabilities, or group identifier. The receiving device may then determine which if any of the decoded identifiers identify the device itself. If the device is identified, then the device is scheduled to communicate during the corresponding time interval. The device may then communicate (transmit or receive data with the TXOP owner) during the corresponding time interval based on the determination.

For example, as shown in FIGS. 7A-C, each schedule block 712 may include a device info field 728. The device info field 728 may include a device ID field 742. In some aspects, the device identifier field 742 is decoded to determine which devices will communicate during a time interval identified by the corresponding schedule block 712.

In some aspects, the frame is further decoded to identify one or more devices that will perform communication with the TXOP owner device during each of the identified plurality of non-overlapping time intervals. The device may then determine whether the device itself is scheduled to perform communication during each of the identified time intervals. Based on this determination, the device can determine periods of time when the device may enter a sleep state. For example, if the frame identifies four time intervals, and the device is scheduled to transmit data to the txop owning device during a first time interval, and receive data from the TXOP owning device during a fourth time interval, then the device may determine it can enter a sleep state during the second and third time intervals.

In some aspects, the frame is further decoded to determine a direction of data transmission during a time interval. For example, decoding the frame may determine whether data will be transmitted to the TXOP owner during a time interval or received from the TXOP owner during the time interval. In some aspects, transmitting data to the TXOP owner is considered an uplink while receiving data from the TXOP owner is considered a downlink. The device may then perform communication with the TXOP owner based on determined direction of data transmission during a particular time interval. If it is determined that data is to be transmitted to the TXOP owner during a time interval, the frame may be further decoded to determine a maximum physical protocol data unit (PPDU) size transmitted during the time interval. Transmissions to the TXOP owner during the time interval may then be limited in response to the determination of the maximum transmission size.

In some aspects, the frame is further decoded to identify when the device should initiate a transmission to the TXOP owner during one of the identified time intervals. In some aspects, the time interval may be the first occurring time interval. For example, if the device is scheduled to transmit data to the TXOP owner during a first occurring time interval, the frame may function as a trigger for the device to initiate the transmission immediately after the frame is received, or after a predetermined period of time has elapsed after reception of the frame is complete (for example, a short inter-frame space time). In some aspects, the frame may be decoded to determine a time offset after reception of the frame when the transmission should be initiated.

In some aspects, the frame is further decoded to identify sleep time information that is separate from the communication scheduling information discussed above. For example, in some aspects, the frame may include explicit sleep schedule information for one or more devices. In some aspects, one or more functions discussed above with respect to block 915 may be performed by the processor 304.

In block 920, a multi-user communication is performed with the TXOP owner during the at least one identified time interval. In some aspects, the multi-user communication includes simultaneous transmission of multiple messages to multiple messages over multiple spatial channels or frequencies, for example, via MU-MIMO or OFDM. In some aspects, the frame received in block 905 is further decoded to determine communication control information for each of the scheduled communications to occur during the TXOP. For example, the device may decode spatial channels and/or frequencies to be used for transmission or reception of data during each time interval for which the device is scheduled for communication. The multi-user communications may then be performed based on the control information decoded from the frame.

In some aspects, a data message transmitted by the TXOP owner and received by the device during one of the time intervals may include sleep time information. The data message may be part of a multi-user communication from the TXOP owner, for example, it may be received via MU-MIMO or OFDM by the device. In some aspects, the data message is decoded to determine a value of an indicator indicating whether the data message is a last data message that the TXOP owner will transmit to the device during the current time interval, or the transmit opportunity. In some aspects, the indicator is a more data bit in a frame control field of the data message.

If the device determines the indicator indicates the data message is the last data message to be received by the device from the TXOP owner during the current time interval or TXOP, the device may enter a sleep state for the remainder of the current time interval or TXOP in response to the determination.

In some aspects, process 900 further includes receiving a second frame from the transmission opportunity owner. This second frame functions as a trigger for the receiving device to transmit data to the TXOP owner during a time interval corresponding to the second frame. The correspondence may be established by the timing of the second frame. For example, the second frame may be transmitted within a time interval. Alternatively, the trigger frame may be decoded to identify the corresponding time interval. For example, each time interval may be identified via an identifier in the first frame received in block 905. The received second frame may then establish the corresponding time interval by including the identifier of the corresponding frame.

In some aspects, the second frame may indicate the receiving device should initiate a transmission immediately after reception of the frame is complete, or after a predetermined offset after the reception (for example, a short inter-frame space time). Alternatively, the second frame may be decoded to determine a time offset within a current time interval when the transmission should be initiated. A transmission to the TXOP owner device may then be initiated based on the indications of the second frame.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method of managing usage of a wireless communication medium in a communication network including a transmitting device and a plurality of receiving devices, comprising:
generating, by a transmitting device, a frame comprising:
a plurality of schedule blocks, each of the schedule blocks comprising:
a first indicator identifying a non-overlapping time interval during a transmission opportunity, and
one or more second indicators of one or more receiving devices to communicate within the non-overlapping time interval, wherein at least one of the plurality of schedule blocks identifies a plurality of receiving devices to communicate within the non-overlapping time interval; and
transmitting the frame from the transmitting device.

2. The method of claim 1, further comprising:
determining a last packet transmitted during the non-overlapping time interval to a particular device of the plurality of receiving devices; and
setting an indication in the last packet to a particular value in response to the determining; and
transmitting the last packet to the particular device.

3. The method of claim 1, further comprising:
determining a last packet transmitted during the transmission opportunity to a particular device of the plurality of receiving devices;
setting an indication in the last packet to a particular value in response to the determining; and
transmitting the last packet to the particular device.

4. The method of claim 1, further comprising:
determining a last packet transmitted during a plurality of transmission opportunities to a particular device of the plurality of receiving devices;
setting an indication in the last packet to a particular value in response to the determining; and
transmitting the last packet to the particular device.

5. The method of claim 1, further comprising generating the frame to further indicate when one or more of the plurality of receiving devices indicated may enter a sleep state.

6. The method of claim 1, further comprising generating the frame to include a time reference for the non-overlapping time interval.

7. The method of claim 1, further comprising generating the frame to comprise power control information for each of the plurality of receiving devices.

8. An apparatus for managing usage of a wireless medium in a communication network including a transmitting device and a plurality of receiving devices, comprising:
a processor configured to generate a frame comprising:
a plurality of schedule blocks, the schedule blocks comprising a contiguous portion of the frame, the schedule blocks further comprising:
a first indicator identifying a non-overlapping time interval during a transmission opportunity, and
one or more second indicators of one or more receiving devices to communicate within the non-overlapping time interval, wherein at least one of the plurality of schedule blocks is generated to identify a plurality of receiving devices to communicate during the non-overlapping time interval; and
a transmitter configured to transmit the frame from the apparatus.

9. The apparatus of claim 8,
wherein the processor is further configured to:
determine a last packet transmitted during the transmission opportunity to a particular device of the plurality of receiving devices,
set an indication in the last packet to a particular value in response to the determination, and
wherein the transmitter is further configured to transmit the last packet to the particular device.

10. The apparatus of claim 8,
wherein the processor is further configured to:
determine a last packet transmitted during the transmission opportunity to a particular device of the plurality of receiving devices,
set an indication in the last packet to a particular value in response to the determination, and
wherein the transmitter is further configured to transmit the last packet to the particular device.

11. The apparatus of claim 8,
wherein the processor is further configured to:
determine a last packet transmitted during a plurality of transmission opportunities to a particular device of the plurality of receiving devices,
set an indication in the last packet to a particular value in response to the determination, and
transmit the last packet to the particular device.

12. The apparatus of claim 8, wherein the processor is further configured to generate the frame to indicate when one or more of the plurality of receiving devices may enter a sleep state.

13. The apparatus of claim 8, wherein the processor is further configured to generate the frame to include a time reference for the non-overlapping time interval.

14. The apparatus of claim 8, wherein the processor is further configured to generate the frame to include power control information for each receiving device.

15. A method of communicating between a transmitting device and a receiving device on a wireless network, comprising:
receiving, by the receiving device, a frame from the transmitting device over the wireless network;
decoding, by the receiving device, the frame to identify a plurality of contiguous schedule blocks;
decoding, by the receiving device, each of the plurality of schedule blocks to determine a corresponding plurality of non-overlapping time intervals during a transmission opportunity (TXOP);
decoding, by the receiving device, each of the plurality of schedule blocks to identify a non-overlapping time interval when the receiving device will perform a multi-user communication with the transmitting device; and
communicating, by the receiving device, with the transmitting device during the identified at least one non-overlapping time interval.

16. The method of claim 15, further comprising:
decoding the frame to determine sleep time information; and
entering a sleep state based on the sleep time information.

17. The method of claim 16, further comprising:
receiving a multi-user data message from the transmitting device during one of the non-overlapping time intervals;
decoding the multi-user data message to determine whether the multi-user data message is a last data message for the receiving device during the one non-overlapping time interval; and
entering a sleep state in response to determining the multi-user data message is the last data message for the receiving device.

18. The method of claim 17, further comprising decoding a more data bit of the multi-user data message to determine whether the multi-user data message is the last multi-user data message for the receiving device.

19. The method of claim 15, further comprising:
decoding the frame to determine a maximum duration of a transmission to the transmitting device during one of the plurality of non-overlapping time intervals; and
transmitting data less than or equal to the maximum transmission duration to the transmitting device during the one non-overlapping time interval based on the decoding.

20. The method of claim 15, further comprising:
receiving a second frame;
decoding the second frame to determine a start time within one of the plurality of non-overlapping time intervals for a data transmission to the transmitting device; and
transmitting data to the transmitting device at the determined start time.

21. The method of claim 15, further comprising decoding the frame to determine a start time within one of non-overlapping time intervals for a transmission of data in a multi-user communication to the transmitting device.

22. The method of claim 15, further comprising:
receiving a second frame;
decoding the second frame to determine a start time within one of the plurality of non-overlapping time intervals for a data transmission to the transmitting device; and
transmitting data to the transmitting device at the determined start time.

23. An apparatus for communicating with a transmitting device on a wireless network, comprising:
a receiver configured to receive from the transmitting device, a frame from the wireless network;
a processor configured to:
decode the frame to identify a plurality of contiguous schedule blocks,
decode each of the plurality of schedule blocks to determine a corresponding plurality of non-overlapping time intervals during a transmission opportunity (TXOP),
decode each of the plurality of schedule blocks to identify at least one of the non-overlapping time intervals when the apparatus will perform a multi-user communication with the transmitting device, and
communicate with the transmitting device during the identified at least one non-overlapping time interval.

24. The apparatus of claim 23, wherein the processor is further configured to:
decode the frame to determine sleep time information, and
enter a sleep state based on the sleep time information.

25. The apparatus of claim 24, wherein the processor is further configured to:
receive a multi-user data message from the transmitting device during one of the non-overlapping time intervals,
decode an indicator in the multi-user data message to determine whether the multi-user data message is a last data message for the apparatus during the time interval, and
enter a sleep state in response to determining the multi-user data message is the last data message.

26. The apparatus of claim 25, wherein the processor is further configured to decode a more data bit of the multi-user data message to determine whether the multi-user data message is the last data message.

27. The apparatus of claim 23,
wherein the processor is further configured to decode the frame to determine a maximum duration of a transmission to the transmitting device during a non-overlapping time interval, and
wherein the transmitter is further configured to transmit data less than or equal to the maximum transmission duration to the transmitting device during the time period based on the decoding.

28. The apparatus of claim 23, wherein the processor is further configured to decode the frame to determine a start time within the non-overlapping time interval for a transmission of data in a multi-user communication to the transmitting device.

29. The apparatus of claim 23,
wherein the receiver is further configured to receive a second frame,
wherein the processor is further configured to decode the second frame to determine a start time within the non-overlapping time interval for a data transmission to the transmitting device, and transmit data to the transmitting device at the determined start time.

30. The apparatus of claim 23, wherein the processor is further configured to decode the frame to determine a start time within the non-overlapping time interval for a transmission of data in a multi-user communication to the transmitting device.
